(19) United States
(12) Patent Application Publication
(10) Pub. No.: US 2012/0163379 A1
(43) Pub. Date: Jun. 28, 2012

(54) MULTICAST ROUTING DEVICE, MULTICAST NETWORK SYSTEM APPLYING THE SAME, AND PACKET TRANSMISSION METHOD

(76) Inventors: Kuo-Lun Chen, Tainan City (TW); Kuen-Long LEU, Hscinchu City (TW)

(21) Appl. No.: 13/336,680

(22) Filed: Dec. 23, 2011

(30) Foreign Application Priority Data
Dec. 24, 2010 (TW) 099145808

(51) Int. Cl. H04L 12/56

(52) U.S. Cl. 370/390

(57) ABSTRACT

A multicast routing device, a network system applying the same, and a packet transmission method are provided. In the system, the multicast routing device is used to provide more than one multicast group point and is connected to a terminal device. When receiving a group switch command, the terminal device imports the address of a currently connected first multicast group point and the address of a second multicast group point to be switched to form a composite multicast packet including the addresses of the two multicast group points and then transmits the composite multicast packet onto a local area network on which the terminal device is located. When receiving the composite multicast packet, the multicast routing device interrupts connection of the terminal device and the first multicast group point and establishes a connection between the terminal device and the second multicast group point.

### CROSS-REFERENCE TO RELATED APPLICATION

This application claims the benefit of Taiwan Patent Application No. 099145808, filed on Dec. 24, 2010, which is hereby incorporated by reference for all purposes as if fully set forth herein.

### BACKGROUND OF THE INVENTION

1. Field of Invention

The present invention relates to a network system for transmitting a multicast packet and a method thereof, and more particularly to a multicast routing device, a network system, and a packet transmission method capable of establishing and transmitting a composite multicast packet including leaving a multicast group and joining another multicast group at the same time.

2. Related Art

Because of its wide use, network technology has become involved in electrical appliances that include home appliance equipment such as a home computer, a vehicle, a transport logistics system, an air conditioner, or a television.

In the case of television nowadays, the Net television (TV) or Internet Protocol (IP) TV also has begun to replace the former television which receives radio broadcast or is connected to cables.

In order to reduce the consumption of network bandwidth by the media data and to solve the data collision problem in the existing IPTV, two protocols are usually used. The first protocol is the Internet Group Management Protocol (IGMP), which is applied in Internet Protocol version 4 (IPv4). Currently three versions exist: RFC 1112-IGMPv1, RFC 2236-IGMPv2, and RFC 3376-IGMPv3. The other protocol used in existing IPTV is the Multicast Listener Discovery (MLD) Protocol, which is applied in Internet Protocol version 6 (IPv6). Currently, two versions exist: RFC 2719-MLDv1 and RFC 3810-MLDv2.

In the aforementioned IPTV system of the IGMP or the MLD, a media provider provides media supply equipment, which is connected to a regional multicast routing device. The media supply equipment requires the multicast routing device to configure more than one multicast group point from IP-224.0.0.0 to IP-239.255.255.255 (In the IGMP technology, the configuration requirement establishes a public conference that receives a multicast data stream) and transmit different media data stream to different multicast group points (each multicast group point is a media channel). When the terminal devices of multiple clients are connected to the multicast routing device, each terminal device can request to connect to any multicast group point by packet sending in a local area network managed by the multicast routing device. At this time, connection members connected to the same multicast group point are regarded as the same multicast group, and each member receives media data stream transmitted from the same multicast group point at the same time as the other members.

When the user wants to switch media channels, the user can use a terminal device to input a channel switch command. The terminal device sends two packets and releases the two packets on a local area network where the terminal device is located. The two packets are a leave multicast group packet and a join multicast group packet. The leave multicast group packet is transmitted by the terminal device to a multicast group point originally connected thereto and is received by the connection members of the multicast group point and the multicast routing device. The terminal device stops receiving data from the original multicast group point, and the multicast routing device also interrupts the connection between the terminal device and the multicast group point originally connected thereto through a routing mechanism. Next, the join multicast group packet points to a target multicast group point, which represents another media channel. The join multicast group packet is received by multicast group members of the target multicast group point and the multicast routing device, and the terminal device attempts to receive media data stream from the target multicast group point. Also, the multicast routing device establishes the connection between the terminal device and the target multicast group point through the routing mechanism to add the terminal device to the multicast group of the target multicast group point.

However, due to undesirable network connection success rate or other external factors, sometimes the leave multicast group packet and/or the join multicast group packet sent by the terminal device separately might get lost, thereby causing the following situations.

(1) The join multicast group packet is lost. The terminal device interrupts the originally connected multicast group point, but does not connect to a new target multicast group point. So the terminal device leaves the multicast group corresponding to the original multicast group point and fails to join a new multicast group of the target multicast group point. The terminal device is unable to receive any media data stream.

(2) The leave multicast group packet is lost. The terminal device fails to interrupt the originally connected multicast group point, but still connects to the new target multicast group point. So, the terminal device joins the new multicast group of the target multicast group point, but the terminal device does not leave the multicast group corresponding to the original multicast group point. The terminal device receives media data stream from two multicast group points at the same time, such that the network bandwidth is occupied and only one of the media data stream can be displayed. Unless the terminal device is turned off, the terminal device continues receiving the original media data stream that failed to be interrupted.

Therefore, manufacturers should consider a method to avoid network bandwidth occupation or failures of receiving relevant data streams due to packet loss when a media channel is switched or when a connected multicast group is switched.

### SUMMARY OF THE INVENTION

The present invention is directed to a packet transmission method, equipment, and system for a composite multicast packet in which leave and join information of multicast groups are combined into one packet to output.

In order to solve the system problems, the present invention provides a multicast network system that can transmit a single composite multicast packet instead of two separate packets in addition to the general normal multicast packets. The system comprises a terminal device and a multicast routing device.

The multicast routing device provides a plurality of multicast group points, and the terminal device is connected to a first multicast group point. The terminal device receives a group switch command pointing to a second multicast group point, generates a composite multicast packet from the multicast group addresses of the two multicast group points, and transmits the packet.

The multicast routing device receives the composite multicast packet and analyzes the composite multicast packet according to the composite packet format. Then, the multicast routing device interrupts the connection between the first multicast group point corresponding to the first multicast group address and the terminal device and establishes a connection between the second multicast group point corresponding to the second multicast group address and the terminal device. The terminal device changes from being a multicast group member of the first multicast point to being a multicast group member of the second multicast point.

In order to solve the equipment problems, the present invention provides a multicast routing device that comprises a packet transceiver unit and a routing processor, provides a plurality of multicast group points and is connected to a terminal device, and is capable of transmitting a composite multicast packet.

The packet transceiver unit receives at least one composite multicast packet conforming to a composite packet format from the terminal device. The composite packet format comprises a packet head field, an original multicast group address field, and a new multicast group address field. The routing processor analyzes the composite multicast packet according to the composite packet format, determines whether or not to interrupt or establish connections between the terminal device and random multicast group point(s), and then interrupts and establishes connections between the terminal device and multicast group points.

In order to solve the method problems, the present invention provides a method for transmitting a composite multicast packet comprises: receiving a command through a terminal device; importing a first multicast group address and a second multicast group address in a composite packet format through the terminal device, thereby generating and outputting a composite multicast packet; receiving a composite multicast packet conforming to a composite packet format from the terminal device by a packet transceiver unit with a packet transceiver unit, wherein the composite packet format comprises a packet head field, an original multicast group address field, and a new multicast group address field; and analyzing the composite multicast packet according to the composite packet format generated by the command and determining whether or not a connection(s) is interrupted or established between the terminal device and a multicast group point(s) through the multicast routing device.

The step of analyzing the composite multicast packet according to the composite packet format and determining whether or not a connection is interrupted or established between the terminal device and a multicast group point through a routing processor further comprising: analyzing the original multicast group address field of the composite multicast packet; determining if the first multicast group address corresponds to a multicast group point; interrupting a connection between the terminal device and the first multicast group point according to the first multicast group address; analyzing the new multicast group address field of the composite multicast pack; determining if the second multicast group address corresponds to a multicast group point in the area; and establishing a connection between the second multicast group point and the terminal device according to the second multicast group address by the multicast routing device.

For features of the present invention, both the multicast routing device and the terminal device in the multicast network system adopt the composite packet format for data communication, and cover the following cases: 1) the multicast routing device fails to receive the leave multicast group packet and the join multicast group packet does not occur, 2) the terminal device joins two multicast groups at the same time and consumes the network bandwidth, and 3) the terminal device leaves the multicast group and does not join a new multicast group thereby not receiving relevant data streams.

### BRIEF DESCRIPTION OF THE DRAWINGS

The present invention will become more fully understood from the detailed description given herein below for illustration only, and thus are not limitative of the present invention, and wherein:

FIG. 1A is a schematic structural view of a multicast network system according to an embodiment of the present invention;

FIG. 1B is a schematic view of group leaving according to an embodiment of the present invention;

FIG. 1C is a schematic view of group selection according to an embodiment of the present invention;

FIG. 1D is a schematic view of group switching according to an embodiment of the present invention;

FIG. 2A is a schematic view of a first composite packet format modified from IGMPv2 format according to an embodiment of the present invention;

FIG. 2B is a schematic view of a leave group multicast packet in a first composite packet format according to an embodiment of the present invention;

FIG. 2C is a schematic view of a select/join group multicast packet in a first composite packet format according to an embodiment of the present invention;

FIG. 2D is a schematic view of a switch group multicast packet in a first composite packet format according to an embodiment of the present invention;

FIG. 3 is a schematic view of a second composite packet format modified from IGMPv3 format according to an embodiment of the present invention;

FIG. 4 is a schematic view of a third composite packet format modified from MLDv1 format according to an embodiment of the present invention;

FIG. 5 is a schematic view of a fourth composite packet format modified from MLDv2 format according to an embodiment of the present invention;

FIG. 6 is a first schematic flow chart of a method for transmitting a composite multicast packet applicable to switch group commands according to an embodiment of the present invention;

FIG. 7 is a second schematic flow chart of a method for transmitting a composite multicast packet applicable to join/select and leave commands according to an embodiment of the present invention; and

FIG. 8 is a schematic flow chart of a method for analyzing and transmitting a composite multicast packet applied in a multicast routing device according to an embodiment of the present invention.

### DETAILED DESCRIPTION OF THE INVENTION

The preferred embodiments of the present invention are illustrated in detail with reference to the accompanying drawings.

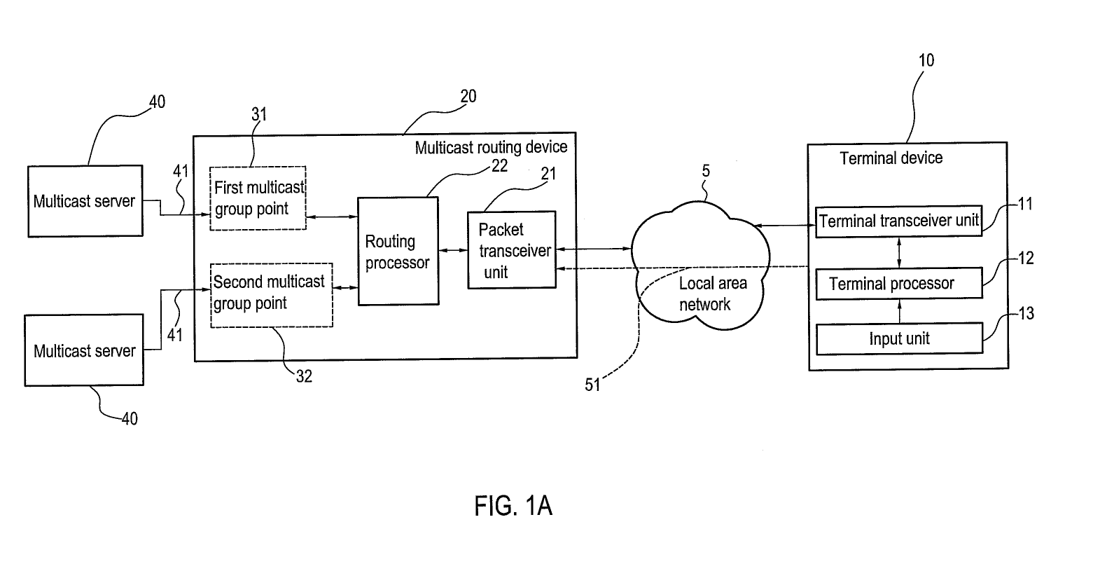

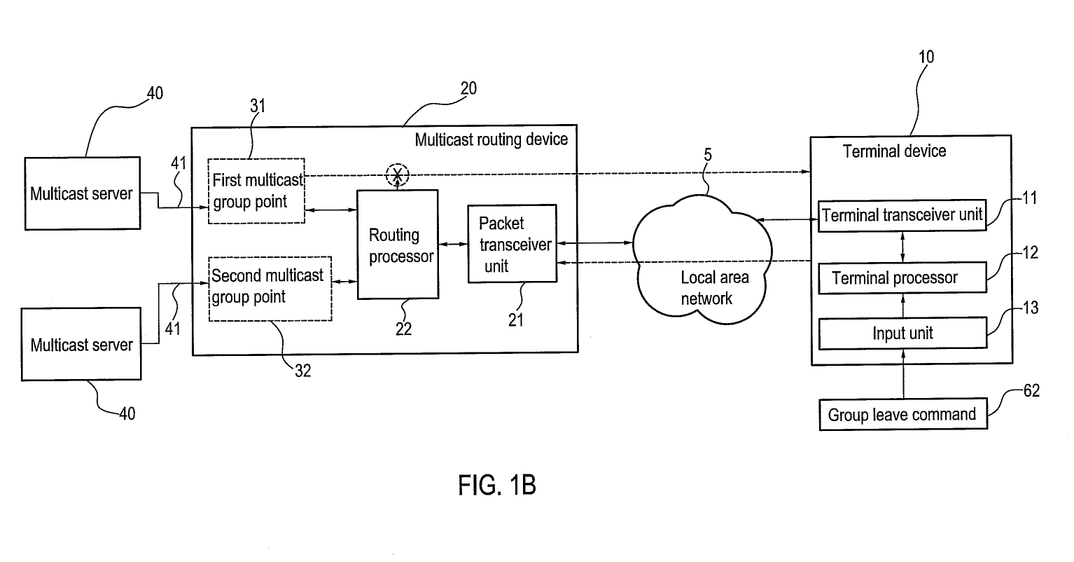

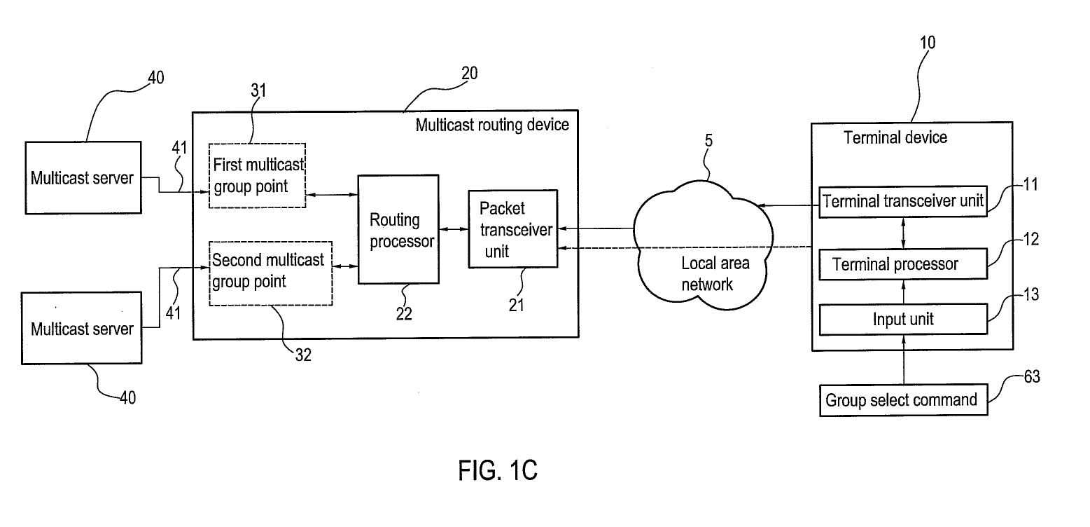

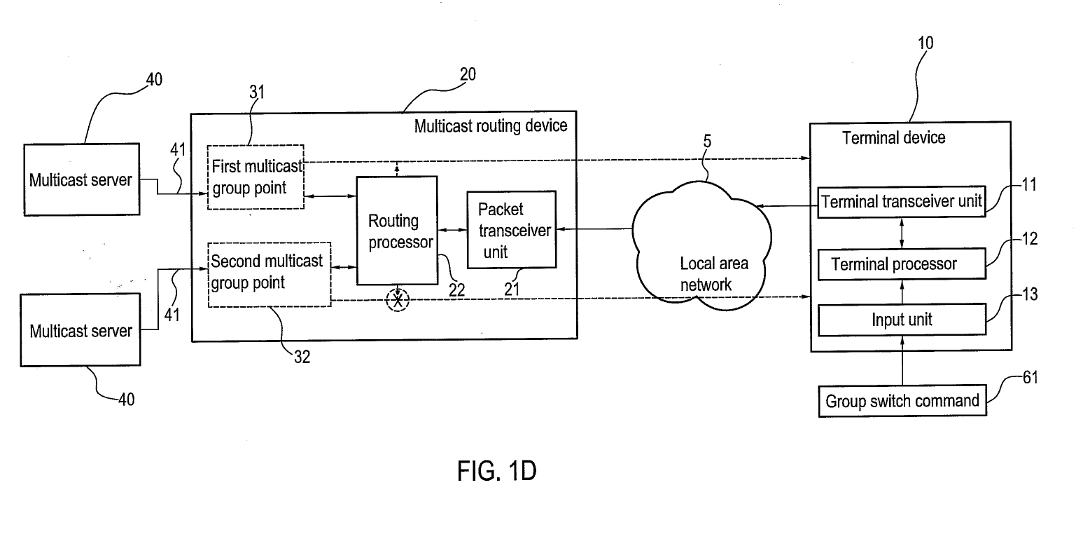

FIG. 1A is a schematic view of a network structure of a multicast network system according to an embodiment of the present invention. The system includes a multicast routing device 20 and a terminal device 10. The multicast routing device 20 is connected to multiple remote multicast servers 40 and receives more than one multicast data stream 41. When each multicast server 40 provides a multicast data stream 41 to the multicast routing device 20, the multicast routing device 20 is requested to configure more than one multicast group point from IP-224.0.0.0 to IP-239.255.255.255 (in the IGMP or MLD technology, the multicast routing device establishes a public conference connection point receiving multicast data streams 41). Each multicast group point transmits a corresponding multicast data stream 41. In an IPTV system, for example, each multicast group point represents a media channel.

The multicast routing device 20 is connected to a local area network 5, and the local area network 5 includes multiple network equipment such as a routing device, a switching device, a bridge device, and a terminal device 10 at a user end. The multicast routing device 20 releases multicast data streams 41 from the multicast group point on the local area network 5. All network equipments that are connected to the same multicast group point are connection members of that multicast group and receive the same respective multicast data stream 41.

For the purpose of this example, two multicast servers 40 are connected to the multicast routing device 20 though the invention also covers situations with more servers. The two multicast servers 40 respectively provide a multicast data stream 41 and request the multicast routing device 20 to provide a first multicast group point 31 and a second multicast group point 32 to transmit the two multicast data streams 41. Here, the network equipments connected to the first multicast group point 31 are regarded as the first multicast group, and the network equipments connected to the second multicast group point 32 are regarded as the second multicast group. The terminal device 10 is connected to the first multicast group point 31 through the multicast routing device 20. It becomes a connection member of the first multicast group and receives the multicast data stream 41 transmitted by the first multicast group point 31. Alternatively, the terminal device 10 is instead connected to the second multicast group point 32 and receives the multicast data transmitted by the second group.

The terminal device 10 includes an input unit 13, a terminal processor 12, and a terminal transceiver unit 11. The input unit 13 receives a control command input from a user, which is either a group switch command 61 (group switch command 61 shown in FIG. 1D), a group leave command 62 (shown in FIG. 1B), or a group select/join command 63 (shown in FIG. 1C). The terminal processor 12 imports the multicast group address of a currently connected multicast group point and the multicast group address of a target multicast group point to be connected or both at the same time in a composite packet format according to different commands and generates either a leave group multicast packet, a select/join group multicast packet, or a composite multicast packet (group switch multicast packet or composite forms of leave group and join group multicast packets), and then transmits the generated multicast packet 51 to the local area network 5 through the terminal transceiver unit 11.

The multicast routing device 20 receives the multicast packet 51 transmitted from the terminal device 10 and determines from the packet head of the multicast packet 51 whether or not the multicast packet 51 needs to be analyzed with a composite packet format. If the packet is not a composite packet form, the multicasting routing device will analyze the packet using the general normal multicast packet form.

If the packet is a composite packet form, the multicast routing device 20 determines if a valid multicast group address is stored in the original multicast group address field of multicast packet 51 and whether or not a group leave operation needs to be performed on the terminal device 10, thereby enabling the terminal device 10 to leave the originally joined multicast group. Next, the multicast routing device 20 and determines whether a valid multicast group address is stored in the new multicast group address field of multicast packet 51 and whether or not a group select/join operation is performed on the terminal device 10, thereby enabling the terminal device 10 to join a new multicast group. When the multicast packet 51 only has multicast address leave data, the multicast packet 51 is the leave group multicast packet. When the multicast packet 51 only has multicast address select data, the multicast packet 51 is the select group multicast packet. When the multicast packet 51 has both the multicast address leave data and the multicast address select data, the multicast packet 51 is the composite multicast packet.

In the following embodiments described below, the first multicast group address of the first multicast group point 31 is, for example, IP:224.0.1.1, and the second multicast group address of the second multicast group point 32 is, for example, IP:224.0.1.2.

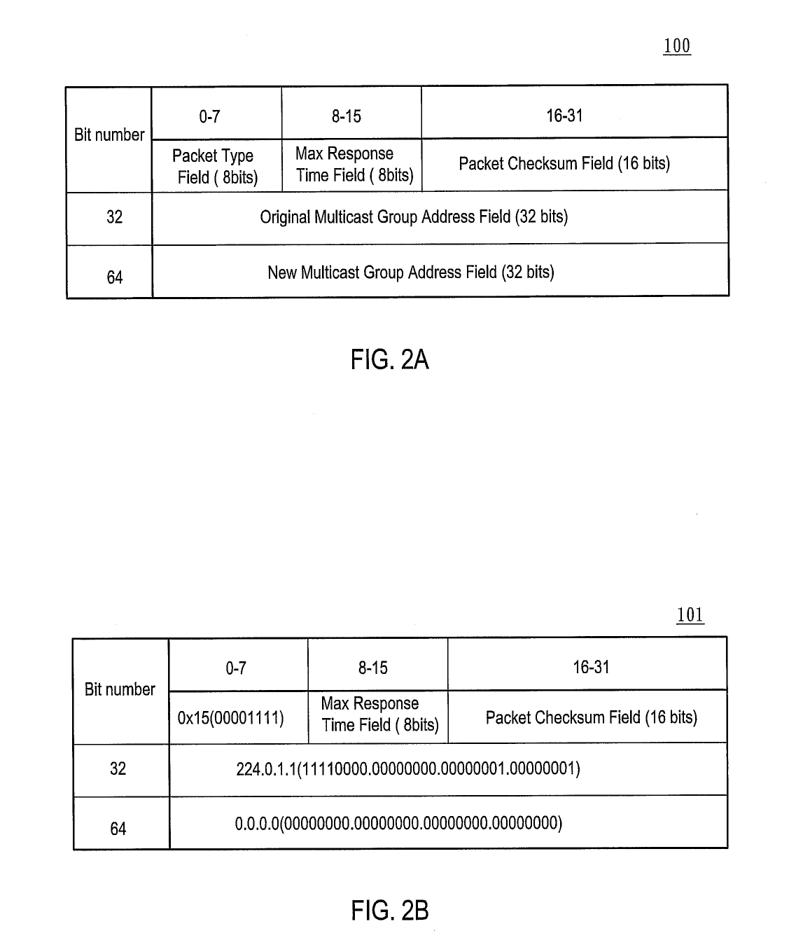

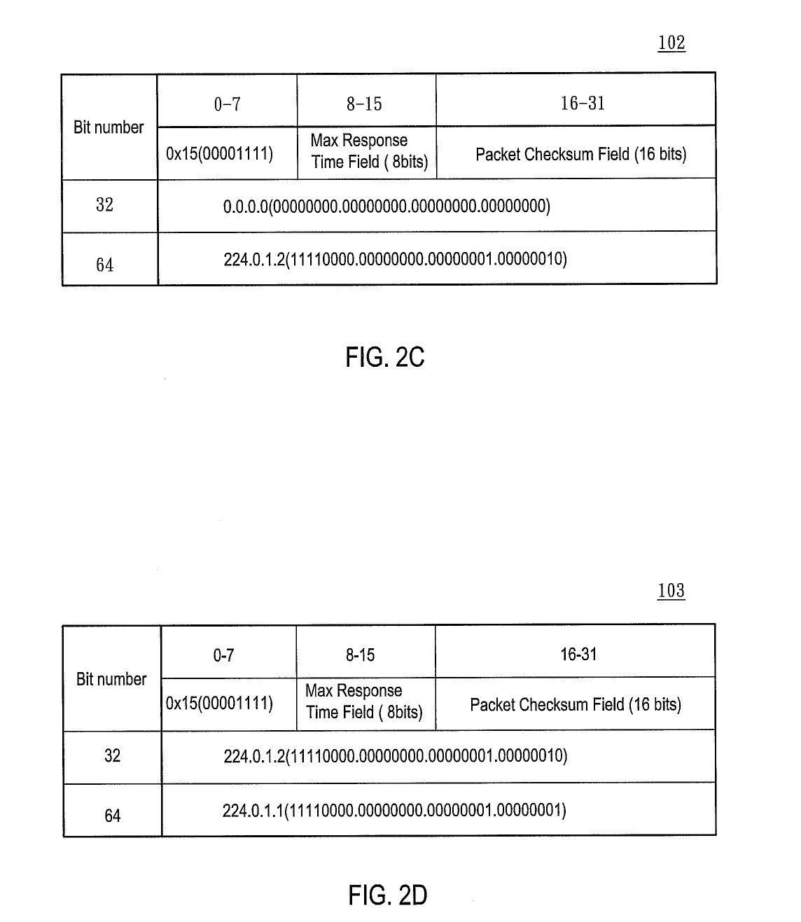

FIG. 2A is a schematic view of a first composite packet format according to an embodiment of the present invention. In this embodiment, the first composite packet format 100 is a modification of the packet format in IGMP version 2 (IGMPv2). In this embodiment, the first composite packet format 100 includes three basic data fields: a packet head, an original multicast group address field, and a new multicast group address field. The original multicast group address holds the first multicast group address. The new multicast group address field holds the second multicast group address.

The packet head includes three packet fields: a packet type field, a max response time field, and a packet checksum field. The packet type field is the type code of the packet. When the terminal device 10 or the multicast routing device 20 generates the multicast packet, the type code of the multicast packet is filled therein. The device that receives the multicast packet looks at the type code to determine whether or not the received multicast packet has a general normal multicast packet format or a composite packet format.

In one embodiment, for example, the multicast routing device 20 determines whether or not to analyze the received multicast packet with the first composite packet format 100 by determining if the packet head of the multicast packet conforms to the first composite packet format 100 to. It should be noted that the terminal device 10 and other network devices in the local area network 5 may also analyze the packets.

The max response time field is the maximum time in which the device receiving the multicast packet is to give a response. However, even if the terminal device 10 transmits a composite multicast packet to perform group switching, and the device receiving the packet does not respond within the time frame, the terminal device 10 assumes that the terminal device 10 joined the second multicast group and starts to attempt to receive the multicast data stream 41 transmitted (or disclosed) at the second multicast group point 32.

The specification of the packet head is in the RFC 2236 specification of IGMPv2. The present invention differs from RFC 2236 in that a packet code of a composite multicast packet is established and each relevant network device determines whether or not the first composite packet format 100 is used. Since the RFC 2236 specification is readily available on the interne, it is not described here.

FIG. 1B is a schematic view of group leaving according to an embodiment of the present invention, and FIG. 2B is a schematic view of a leave group multicast packet in a first composite multicast format according to an embodiment of the present invention. When the terminal device 10 is a connection member of the first multicast group point 31, and a user inputs a group leave command 62 (to stop receiving the currently connected multicast data stream 41 and disconnects from that group) through an input unit 13, the terminal device 10 generates a first multicast group address (224.0.1.1) corresponding to the first multicast group point 31, imports the first multicast group address (224.0.1.1) in the first composite packet format 100 (shown in FIG. 2A), and forms a leave group multicast packet 101 (shown in FIG. 2B). A specific packet type code is set in the packet type field of the leave group multicast packet 101, and the leave group multicast packet 101 is broadcasted in the local area network 5. In addition, in this embodiment, a dedicated packet type code of the composite packet format, for example 0x15, differs from the packet type code in IGMPv2 in the RFC2236 specification.

The first multicast group address (224.0.1.1) is recorded in the original multicast group address field of the leave group multicast packet 101, and the new multicast group address field is filled with random a specific value. For example, each bit in the new multicast group address field is replaced by 0 or 1. However, the present invention is not limited thereto, and other random specific codes can also be used.

The multicast routing device 20 receives the leave group multicast packet 101, and analyzes the leave group multicast packet 101 according to the first composite packet format 100 in FIG. 2A and will interrupt the connection between the first multicast group point 31 and the terminal device 10 according to the first multicast group address (224.0.1.1). The terminal device 10 also stops receiving the multicast data stream 41 from the first multicast group point 31 at the same time to leave the first multicast group. Since there is no valid multicast group address in the new multicast group address field of a leave group multicast packet 101, the multicast routing device 20 will not establish connections between the terminal device 10 and other multicast group addresses. Note that when the terminal device 10 is a connection member of other multicast groups, the action of the group leave can also be accomplished in the above manner, but the present invention is not limited to the above manner.

FIG. 1C is a schematic view of group selection/join according to an embodiment of the present invention, and FIG. 2C is a schematic view of a select group multicast packet in a first composite packet format according to an embodiment of the present invention.

In this embodiment, the terminal device 10 is not a connection member of any other multicast group points. When a user inputs a group select/join command 63 (which includes a multicast group point address, a multicast group number or channel code, and a multicast group address to be selected by the user), through an input unit 13, the terminal device 10 generates multicast address select data (the multicast address of the multicast group to join) according to the group select/join command 63, imports the multicast address select data in a composite packet format, and forms a select group multicast packet. The multicast address select data is recorded in the new multicast group address field, and the original multicast group address field is replaced by random specific values (such as bits of 0's and 1's). The specific values are an example, and the invention is not limited to those values or forms. The terminal device 10 then broadcasts the select group multicast packet into the local area network 5.

Subsequently, the multicast routing device 20 analyzes the composite multicast packet according to the composite packet format, determines which multicast group point was selected, and establishes a connection between the terminal device 10 and the selected multicast group point (which could be second multicast group point 32, first multicast group point 31, or other multicast group points). Since there is no valid target multicast group address in the Original multicast group address field of the select group multicast packet and preexisting connection to a group point, the multicast routing device 20 will not need to have the terminal device “leave” any groups by interrupting the connection.

For example, if the multicast address select data is the second multicast group address, the terminal device 10 imports the second multicast group address (224.0.1.2) in the New multicast group address field of the first composite packet format 100 to generate a select group multicast packet 102. After analyzing the select group multicast packet 102, the multicast routing device 20 establishes the connection between the second multicast group point 32 and the terminal device 10 corresponding to the second multicast group address.

FIG. 1D is a schematic view of group switching according to an embodiment of the present invention, and FIG. 2D is a schematic view of a switch group multicast packet in a first composite multicast packet format according to an embodiment of the present invention.

For example, assume a user inputs a group switch command 61 pointing to the first multicast group point 31 through an input unit 13, and the terminal device 10 is a member of the second multicast group point 32. The terminal device 10 forms composite multicast packet 103 (shown in FIG. 2D) with the first composite packet format 100 (shown in FIG. 2A). The second multicast group address (224.0.1.2) of the second multicast group point 32 is imported into the original multicast group address field, and the first multicast group address (224.0.1.1) of the first multicast group point 31 is imported into the new multicast group address field.

The multicast routing device 20 receives the composite multicast packet 103, analyzes the information in the composite multicast packet 103, interrupts the connection between the terminal device 10 and the second multicast group point 32 corresponding to the second multicast group address, and also establishes a connection between the terminal device 10 and the first multicast group point 31 corresponding to the first multicast group address. Because of the connection changes, at the same time, the terminal device 10 stops receiving the multicast data stream 41 from the second multicast group point 32 (leaving the second multicast group) and starts to receive the multicast data stream 41 from the first multicast group point 31 (joining the first multicast group). Note that when the terminal device 10 is a connection member of other multicast groups, the group switching action can also be accomplished in the above manner, and the present invention is not limited thereto.

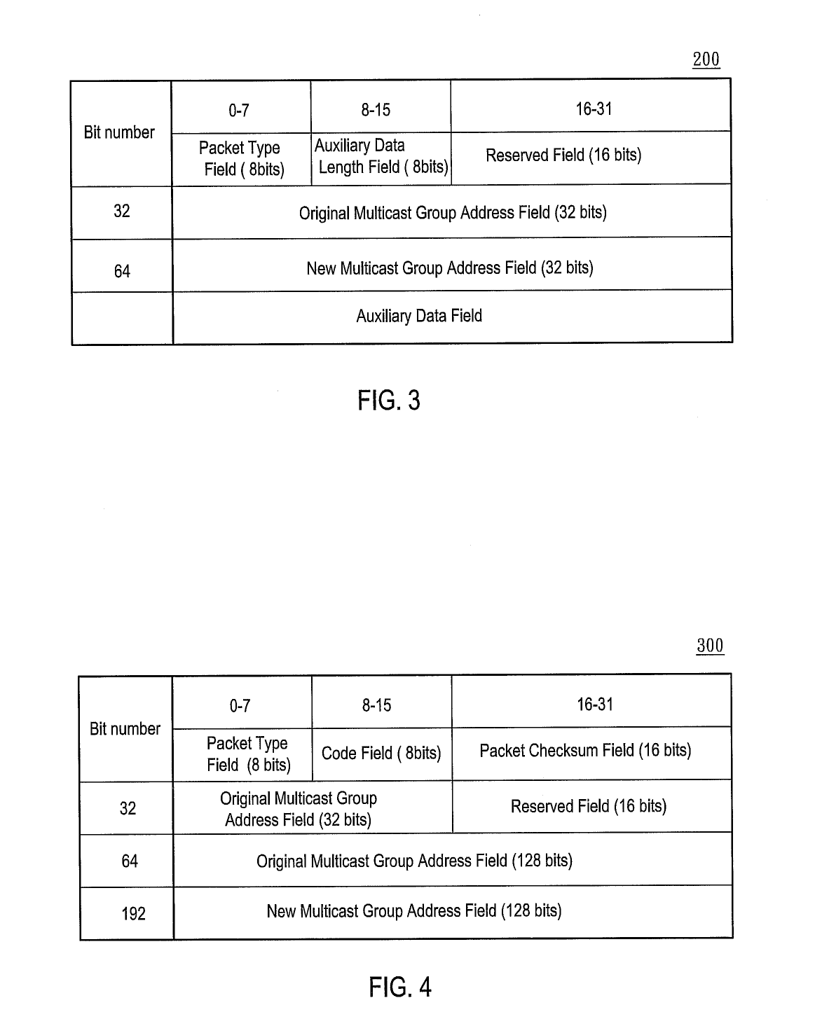

FIG. 3 is a schematic view of a second composite packet format according to an embodiment of the present invention. In this embodiment, the composite packet format is a modification of the packet format in IGMP version 3 (IGMPv3).

In this embodiment, the second composite packet format 200 includes multiple basic data fields: a packet head, an Original multicast group address field, a new multicast group address field, and an Auxiliary Data Field. The packet head field includes a Packet Type Field, an Auxiliary Data Length Field, and a Reserved Field. The Packet Type Field indicates whether the packet is an Include Packet or an Exclude Packet and shows the multicast routing device 20 which multicast group the terminal device 10 sending the packet intends to join or leave.

In this embodiment, a multicast address leave data (the multicast address of a multicast group that the terminal device 10 originally joins) and multicast address select/join data (the multicast address of a target multicast group that the terminal device 10 intends to join) are combined in the same multicast packet so a group switch command can be executed with one composite pocket instead of two separate packets. The packet type code of the composite multicast packet differs from the packet type code of other general IGMPv3 multicast packets. For example, the dedicated Packet Type code/field of the second composite packet format 200 can be 0x7, which is different from the packet type code in IGMPv3 in the RFC3376 specification.

The Auxiliary Data Length Field indicates a data length of the Auxiliary Data Field, and the Reserved Field currently has no specified use. The data specification can be set by the manufacturers.

The Auxiliary Data Field adds description related to the packet. Note that IGMPv3 does not describe formulated specification for the Auxiliary Data Field.

The implementation modes of the packet head field, the original multicast group address field, and the new multicast group address field are similar to the implementation modes of the IGMPv2. The specification of the packet head in this embodiment is also recorded in the RFC 3376 specification in the IGMPv3. The present invention differs from RFC 3376 in that a packet type code for the composite multicast packet is established and each relevant network device determines whether or not the second composite packet format 200 is used.

FIG. 4 is a schematic view of a third composite packet format according to an embodiment of the present invention. In this embodiment, the third composite packet format 300 is modified from the packet format in MLD version 1 (MLDv1), which is used in a network based on IPv6. The use method of the third composite packet format 300 is similar to the embodiments as disclosed in FIG. 2A to FIG. 2D, except that the packet format (e.g. the packet field, the field definition, and the packet length) are different and based on MLDv1.

In this embodiment, the third composite packet format 300 includes three basic data fields: a packet head, an original multicast group address field, and a new multicast group address field. The packet head includes multiple packet fields: a packet type field, a code field, a packet checksum field, a max response time field, and a Reserved Field. The packet type field records type code of the multicast packet when the terminal device 10 or the multicast routing device 20 generates a multicast packet. The device that receives the multicast packet determines from the type code whether or not the received multicast packet has a general normal multicast packet format or a composite packet format. The dedicated packet type code of the third composite packet format 300, for example, could be 0x133 and different from the packet type code of MLDv1of the RFC2710 specification. As with the other composite packet forms and methods, terminal device 10 and other network devices in addition to the multicast routing device 20 can also perform these functions and methods.

The device that sends the packet, such as the multicast routing device 20 or the terminal device 10, imports a device code thereof in the code field, so the receiving device receives the source of the packet.

The max response time field refers to the maximum time within which the device that receives the packet is to give a response. It operates in a similar manner as the max response time field in the first composite packet format in FIG. 2A. To avoid redundancy, refer to the description in the first composite packet format section.

The specification of the packet head is recorded in the RFC 2710 specification of the MLDv1 (similar to the first composite packet head being recorded in RFC 2236 specification of IGMPv2). The present invention differs from RFC2710 in that the packet type code of the composite multicast packet is established and a determination on whether or not the composite packet format is used is made.

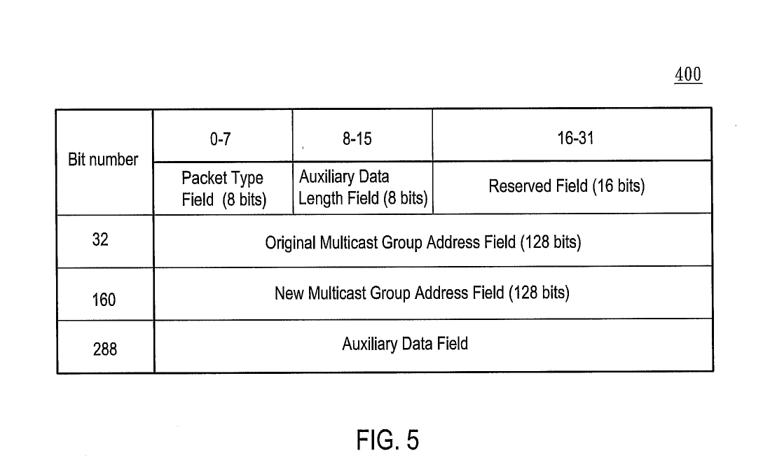

FIG. 5 is a schematic view of a fourth composite packet format according to an embodiment of the present invention. In this embodiment, the fourth composite packet format 400 is a modification of the packet format in the MLD version 2. Therefore, the fourth composite packet format 400 is applicable to a network based on the IPv6. The implementation method and specifications of the fourth composite packet format 400 is similar to the embodiments in for the second composite packet format 200 (FIG. 3) and IGMPv3. The specification of the packet head of the fourth composite packet format 400 is recorded in the RFC 3810 specification in MLDv2. The present invention differs from RFC 3810 in that the packet code of the composite multicast packet is newly established and various network devices can determine whether or not the composite packet format is used.

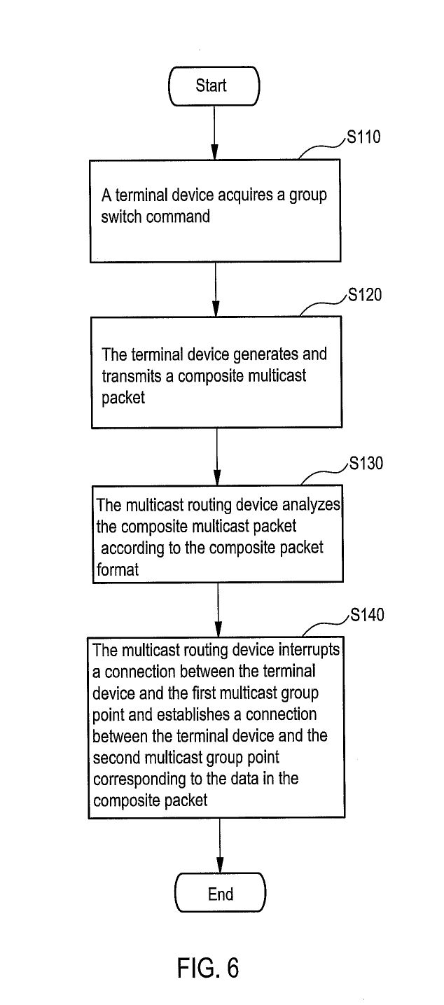

FIG. 6 is a first schematic flow chart of a method for transmitting a switch group composite multicast packet according to an embodiment of the present invention. The mode is applicable to a mechanism in a switch group (a leave and join) is performed, and the steps are illustrated as follows. In this embodiment, a terminal device 10 and a multicast routing device 20 are connected to each other. The multicast routing device 20 provides a first multicast group point 31 and a second multicast group point 32, and the two multicast group points are used for outputting multicast data streams 41 provided by a multicast server 40. The terminal device 10 is a member of the first multicast group point 31, and the user wants to switch the terminal device 10 connection from the first multicast point to the second multicast point. The method includes the following steps:

First, in Step S110, the terminal device 10 connected to a first multicast group point 31 receives a group switch command 61 pointing to the second multicast group point 32. The terminal device 10 includes an input unit 13, a terminal processor 12, and a terminal transceiver unit 11. The input unit 13 is the unit that receives a control command input by a user, which is a group switch command 61, a group leave command 62, or a group select command 63. In this example, though, the user inputs a group switch command 61 pointing to a second multicast group point 32.

In Step S120, the terminal processor 12 in terminal device 10 imports the multicast group addresses of the first multicast group point 31 and the second multicast group point 32 in a composite packet format and generates a composite multicast packet. Next, the terminal processor 12 transmits the composite multicast packet into the local area network 5 through the terminal transceiver unit 11.

In Step S130, the multicast routing device 20 receives the composite multicast packet and analyzes the composite multicast packet according to the composite packet format. The composite packet format includes a packet head field, an original multicast group address field, and a new multicast group address field. The different composite packet formats have already been discussed above in the descriptions of FIGS. 2A, 3, 4, and 5).

Next, in Step S140, the multicast routing device 20 interrupts a connection between the terminal device 10 and the first multicast group point 31 corresponding to the first multicast group address and establishes a connection between the terminal device 10 and the second multicast group point 32 corresponding to the second multicast group address. Thus, the terminal device 10 leaves the first multicast group and joins the second multicast group.

However, the embodiment is not limited thereto and the methods are also applicable where terminal device 10 is switched to other multicast groups.

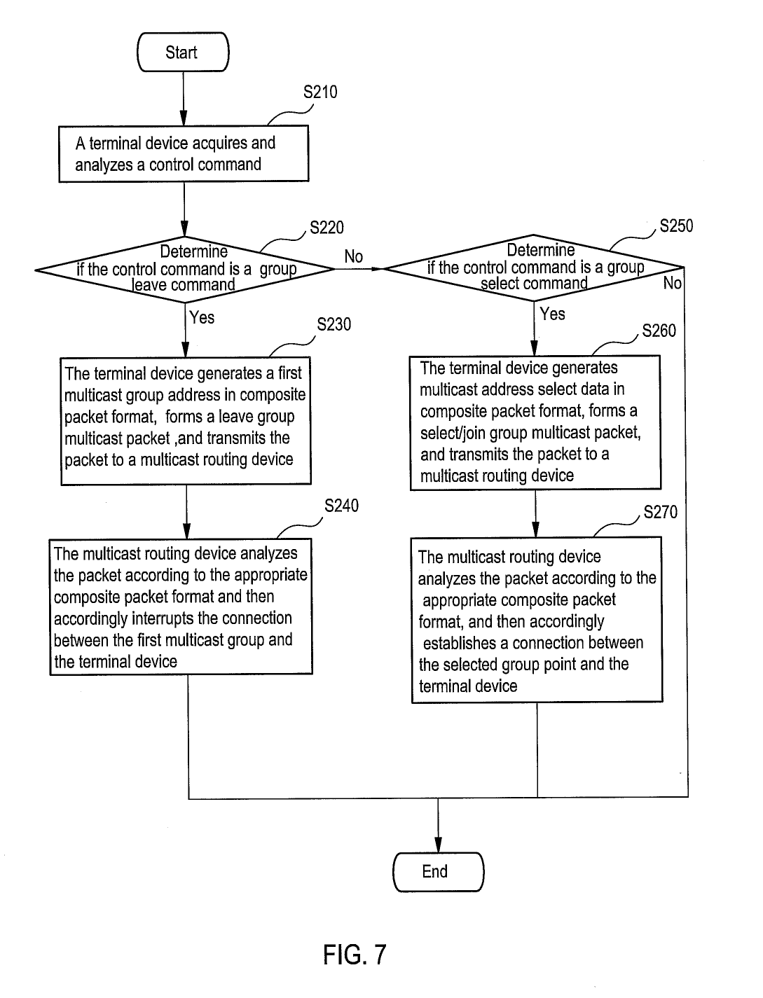

FIG. 7 is a second schematic flow chart of a method for transmitting a composite multicast packet according to an embodiment of the present invention. The mode is applicable to a mechanism in which only join/select group or leave group are performed, and the steps are illustrated as follows.

First, in Step S210, a terminal device 10 receives and analyzes a control command. Next, in Step S220, the terminal device 10 determines whether or not the control command is a group leave command 62. If the command is a group leave command, in Step S230, the terminal device 10 generates a first multicast group address, imports the first multicast group address in a composite packet format to form a leave group multicast packet 101, and transmits the leave group multicast packet 101 to a multicast routing device 20. In this leave group example, assume that the terminal device 10 is initially connected to the first multicast group 31. In Step S240, the multicast routing device 20 analyzes the leave group multicast packet (for example, 101) according to the composite packet format and interrupts the connection between the first multicast group point 31 and the terminal device 10 corresponding to the first multicast group address.

On the contrary, if the control command is not a group leave command 62, in Step S250, the terminal device 10 determines if the control command is a group select command 63. If the terminal device 10 is not a connection member of any multicast group point and receives the group select command 63, in Step S260, the terminal device 10 generates multicast address select data, imports the multicast address select data in a composite packet format and forms a select group multicast packet 102, and outputs the select group multicast packet 102 to the multicast routing device 20. In the generated composite packet format, the multicast address select data is in the new multicast group address field of the select group multicast packet, and the original multicast group address field is replaced by a specific value, which for example, could be bits replaced by 0's or 1's. Next, in Step S270, the multicast routing device 20 analyzes the select group multicast packet (for example, 102) according to the composite packet format, determines which multicast group point should be connected to the terminal device, and establishes the connection between the appropriate multicast group point and the terminal device 10.

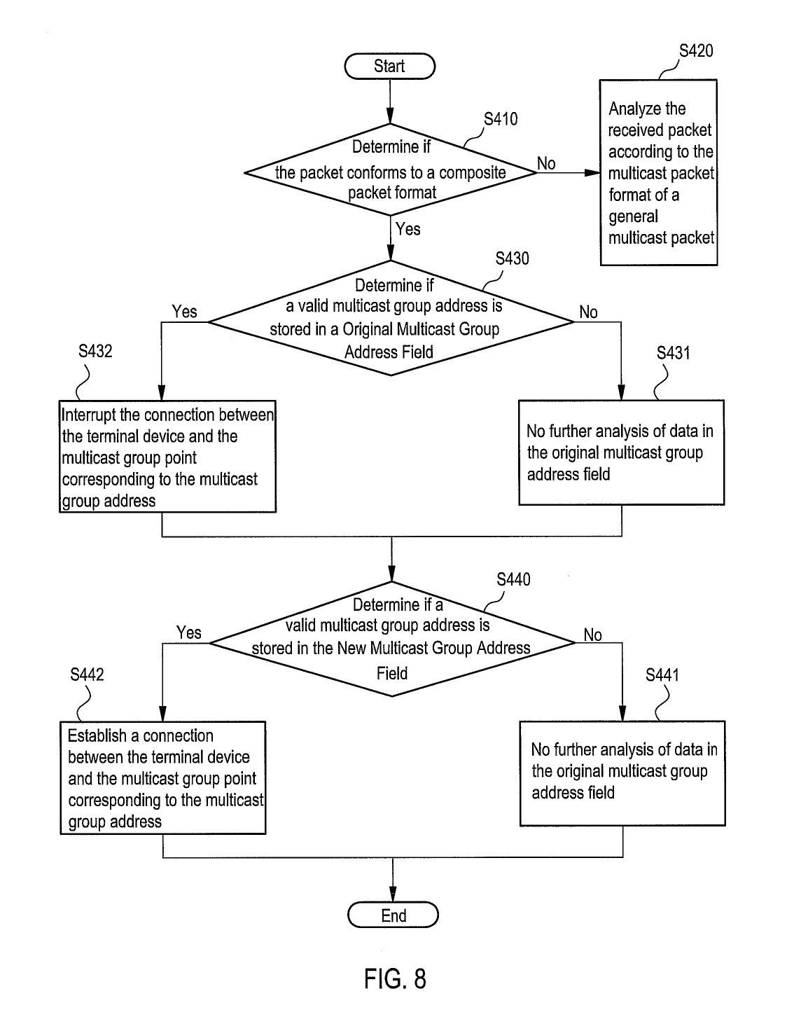

FIG. 8 is a flow chart schematic of a method for analyzing and transmitting a composite multicast packet applied in a multicast routing device according to an embodiment of the present invention. The multicast routing device 20 provides a plurality of multicast group points and is connected to a terminal device 10 through a network. As shown in FIG. 1A, the multicast routing device 20 includes a packet transceiver unit 21 and a routing processor 22. The packet transceiver unit 21 receives packet data of the following types: (1) a multicast data stream 41 transmitted by the multicast server 40; and (2) the multicast packet 51 transmitted by the network equipment received from the local area network 5, in which the network equipment is, for example, a terminal device 10, a switching device or a routing device of the user.

First, in Step S410, the packet transceiver unit 21 receives a packet transmitted by a terminal device 10 and the routing processor 22 determines whether or not the packet conforms to a composite packet format. If the packet is not composite, the multicast packet will be analyzed in the format of a general multicast packet in Step S420. If, however, the routing processor 22 determines that the packet conforms to the composite packet format, in Step S430, the processor determines if a valid multicast group address is stored in an original multicast group address field.

If the original multicast group address is not valid, in Step S431, the routing processor 22 will not further analyze the data in the original multicast group address field. For example, as given in examples in the above embodiments, if all the bits are 0's or are 1's or a random specific set value, then the processor will determine that the address is invalid and determine the composite packet does not include any address leave data. If, however, the original multicast group address is valid, in Step S432, the routing processor 22 interrupts the connection between the terminal device 10 and the multicast group point corresponding to the multicast group address.

Next, in Step S440 the routing processor 22 determines whether or not a valid multicast group address is stored in the new multicast group address field of the composite multicast packet. The analysis is similar to the analysis for the original multicast group address. If the multicast group address stored in the new multicast group address field is invalid, in Step S441, the processor will not analyze the information further. If, however, the address is valid, in Step S442, the routing processor 22 establishes the connection between the terminal device 10 and the multicast group point corresponding to the new multicast group address.

In this embodiment, there are three scenarios.

1) If the original multicast group address is valid and the new multicast group address is invalid, then the packet is the leave group multicast packet. An example situation is illustrated in an embodiment in FIG. 1B, where the routing processor 22 receives a group leave command and interrupts the connection between terminal device 10 and a first multicast group 31 that it was connected to.

2) If the original multicast group address is invalid and the new multicast group address is valid, then the packet is the join/select group multicast packet. An example situation is illustrated in an embodiment in FIG. 1C, where routing processor 22 receives a group select/join command and establishes a connection between terminal device 10 and a second multicast group 32 that the group select command designates.

3) If both the addresses in the original multicast group address field and the new multicast group address field of the composite multicast packet are valid, then the packet is a group switch composite packet with a leave and join command. An example situation is illustrated in an embodiment in FIG. 1D, where routing processor 220 receives a group switch command, disconnects terminal device 10 from a second multicast group point 32, and connects terminal device 10 to a first multicast group 31.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A multicast network system for transmitting a composite multicast packet, comprising:
a terminal device, connected to a first multicast group point, which receives a group switch command pointing to a second multicast group point and imports a first multicast group address and a second multicast group address in a composite packet format, thereby generating and transmitting a composite multicast packet; and
a multicast routing device, having the first multicast group point and the second multicast group point, and other multicast group points, which receives the composite multicast packet, analyzes the composite multicast packet according to the composite packet format, determines which connection to interrupt between a multicast group point and the terminal device according to the first multicast group address and which multicast group point to establish a connection with the terminal device according to the second multicast group address, interrupts the connection between the terminal device and first multicast group point, and establishes a connection between the terminal device and second multicast group point.

2. The multicast network system for transmitting a composite multicast packet according to claim 1, wherein:
when the terminal device is a connection member of the first multicast group point and receives a group leave command, the terminal device generates the first multicast group address, imports the first multicast group address in the composite packet format, forms a leave group multicast packet with the first multicast group address in the original multicast group address field of the leave group multicast packet, transmits the packet; and
the multicast routing device analyzes the leave group multicast packet according to the composite packet format, determines whether or not to interrupt the connection between the first multicast group point and the terminal device according to the first multicast group address, and interrupts the connection between the first multicast group point and the terminal device.

3. The multicast network system for transmitting a composite multicast packet according to claim 2, wherein
when the terminal device is not a connection member of any group point and receives a group select/join command, the terminal device generates multicast address select data, imports the multicast address select data in the composite packet format, and forms a select group multicast packet with the multicast address select data in the new multicast group address field of the select group multicast packet, transmits the packet; and
the multicast routing device analyzes the composite multicast packet according to the composite packet format, determines which multipoint group point to establish a connection to the terminal device to the multicast address select data, and establishes the connection between the multicast group point corresponding to the multicast address select data and the terminal device.

4. A multicast routing device capable of transmitting a composite multicast packet, provides a plurality of multicast group points, and is connected to a terminal device, comprising:
a packet transceiver unit, used to receive at least one composite multicast packet conforming to a composite packet format from the terminal device, wherein the composite packet format comprises a packet head field, an original multicast group address field, and a new multicast group address field; and
a routing processor, used to analyze the composite multicast packet according to the composite packet format to determine whether or not a connection is established or interrupted between the terminal device and a random multicast group point if the composite packet format is valid.

5. The multicast routing device according to claim 4, wherein the routing processor analyzes the original multicast group address field of the composite multicast packet to obtain a first multicast group address, determines whether or not data of the first multicast group address corresponds to a first multicast group point among the multicast group points, and decides whether or not to interrupt a connection between the terminal device and the first multicast group point.

6. The multicast routing device according to claim 5, wherein the routing processor analyzes the new multicast group address field of the composite multicast packet to obtain a second multicast group address, determines whether or not data of the second multicast group address corresponds to a second multicast group point among the multicast group points, and determines whether or not to establish a connection between the terminal device and the second multicast group point.

7. The multicast routing device according to claim 4, wherein the routing processor, when any multicast packet is received, analyzes the packet head of the any multicast packet, determines whether or not the any multicast packet has a composite packet format, and then determines whether or not to analyze the any multicast packet according to the composite packet format.

8. A method for transmitting a composite multicast packet comprising,
receiving a command through a terminal device;
importing a first multicast group address and a second multicast group address in a composite packet format through the terminal device, thereby generating and outputting a composite multicast packet;
receiving a composite multicast packet conforming to a composite packet format from the terminal device by a packet transceiver unit with a packet transceiver unit, wherein the composite packet format comprises a packet head field, an original multicast group address field, and a new multicast group address field; and
analyzing the composite multicast packet according to the composite packet format generated by the command and determining whether or not a connection(s) is interrupted or established between the terminal device and a multicast group point(s) through the multicast routing device.

9. The method for transmitting a composite multicast packet according to claim 8, wherein the command is a group switch command that points to a second multicast group point when the terminal device is connected to a first multicast group point;
the step of analyzing the composite multicast packet according to the composite packet format and determining whether or not a connection is interrupted or established between the terminal device and a multicast group point through a routing processor further comprising:
analyzing the original multicast group address field of the composite multicast packet;
determining if the first multicast group address corresponds to a multicast group point;
interrupting a connection between the terminal device and the first multicast group point according to the first multicast group address;
analyzing the new multicast group address field of the composite multicast pack;
determining if the second multicast group address corresponds to a multicast group point in the area; and
establishing a connection between the second multicast group point and the terminal device according to the second multicast group address by the multicast routing device.

10. The method for transmitting a composite multicast packet according to claim 9, further comprising:
When the command is a leave command as the terminal device is connected to a first multicast group point; generating the first multicast group address and importing the first multicast group address in the composite packet format, forming a leave group multicast packet and outputting the leave group multicast packet to the multicast routing device through the terminal device; and
analyzing the composite multicast packet according to the composite packet format, determining which multicast group point is disconnected from the terminal device according to the first multicast group address in the packet.

11. The method for transmitting a composite multicast packet according to claim 10, further comprising:
When the command is a join/select command with multicast address select data as the terminal device is not a member of any multicast group point;
generating multicast address select data, importing the multicast address select data in the composite packet format, forming a select group multicast packet and outputting the select group multicast packet to the multicast routing device through the terminal device; and
analyzing the composite multicast packet according to the composite packet format and, establishing the connection between the selected multicast group point and the terminal device according to the multicast address select data through the multicast routing device.

12. The method for analyzing a composite multicast packet in a multicast routing device, comprising:
analyzing a packet head of the any received multicast packet, and determining whether or not the any multicast packet has a composite packet format, and determining whether or not to analyze the multicast packet according to the composite packet format; and analyzing received packet with a general multicast packet format if the packet is not a composite format and analyzing received packet with a composite packet format if the packet is a composite format;

13. The method for analyzing a composite packet format according to claim 12 comprising:
determining whether a valid multicast group address is stored in an original Multicast Group Address Field;
interrupting the connection between the terminal device and the multicast group point corresponding to the multicast group address if a valid multicast group address is in the Old Multicast Group Address field determining if a valid multicast group address is stored in the New Multicast Group Address Field; and
establishing a connection between the terminal device and the multicast group point corresponding to the multicast group address if a valid multicast group address is in the New Multicast Group Address field.
